(19) United States
(12) Patent Application Publication
(10) Pub. No.: US 2025/0208921 A1
(43) Pub. Date: Jun. 26, 2025

(54) Systems, Methods And Interfaces for Schedule Migration And Validation for Distributed Systems And Mainframe Systems

(71) Applicant: Elevance Health, Inc., Indianapolis, IN (US)

(72) Inventor: Rajagopalan SUBRAMANIAN, Indianapolis, IN (US)

(73) Assignee: Elevance Health, Inc., Indianapolis, IN (US)

(21) Appl. No.: 18/987,035

(22) Filed: Dec. 19, 2024

Related U.S. Application Data
(60) Provisional application No. 63/614,777, filed on Dec. 26, 2023.

(51) Int. Cl. G06F 9/50

(52) U.S. Cl. CPC G06F 9/5038

(57) ABSTRACT

A system and method are provided for migrating and/or validating schedules for mainframe systems and/or distributed systems. The method may include interfacing with a plurality of schedulers including a source scheduler and a target scheduler. Each scheduler may be configured to schedule jobs across one or more distributed systems and one or more mainframe systems. The method may include obtaining a source schedule generated by the source scheduler and a target schedule generated by the target scheduler for a same system of the one or more distributed systems and one or more mainframe systems. The method may include determining validity of migration of jobs between the source schedule and the target schedule. The method may include, in accordance with a determination that one or more jobs in the target schedule are not valid, transmitting an indication to the target scheduler causing the target scheduler to correct the schedule.

### RELATED APPLICATIONS

This application claims priority to U.S. Provisional Application No. 63/614,777, titled “Systems, Methods And Interfaces for Schedule Migration And Validation for Distributed Systems And Mainframe Systems,” filed Dec. 26, 2023, which is hereby incorporated by reference in its entirety.

### FIELD

The invention relates to systems, methods and interfaces for managing information technology systems, and is more particularly, but not by way of limitation, directed to technology for schedule migration and validation for distributed systems and mainframe systems.

### BACKGROUND

Application workflow orchestration platforms allow businesses to run hundreds of thousands of batch jobs and use data to optimize complex business operations. Workload management software may define, monitor and manage scheduled and event-based workloads across enterprise applications in different operating systems, hybrid and multi-cloud environments. Tools and systems may provide access to enterprise batch jobs through graphical interfaces. Some workflow management software may integrate with distributed storage systems. Distributed systems and mainframe systems require different schedules, but a same workflow management system may be required to schedule jobs across these systems. Workflow automation systems (e.g., BMC Control-M (CTM), Broadcom's ESP) provide different capabilities and cost advantages.

### SUMMARY

Accordingly, there is a need for tools, systems, methods and interfaces for migrating and/or validating schedules generated by different workflow automation systems for mainframe and/or distributed systems. Some embodiments ensure that job linkages between different schedulers are appropriately configured with proper predecessor and successor relationships. To facilitate efficient verification of migrated schedules, a schedule validator may be provided to application owners.

One or more embodiments of the invention are directed to an improved method and system for migrating and/or validating schedules for mainframe systems and/or distributed systems. The method may be performed at a server having one or more processors, memory, one or more displays, and one or more programs stored in the memory and configured for execution by the one or more processors, the one or more programs including instructions for performing the steps described herein. The method may include interfacing with a plurality of schedulers including a source scheduler and a target scheduler. Each scheduler may be configured to schedule jobs across one or more distributed systems and one or more mainframe systems. The method may include obtaining a source schedule generated by the source scheduler and a target schedule generated by the target scheduler for a same system of the one or more distributed systems and one or more mainframe systems. The method may include determining validity of migration of jobs between the source schedule and the target schedule. The method may include, in accordance with a determination that one or more jobs in the target schedule are not valid, transmitting an indication to the target scheduler causing the target scheduler to correct the target schedule.

In some embodiments, the method may further include, prior to determining validity of migration of jobs, cleansing and pre-processing the source schedule and the target schedule.

In some embodiments, cleansing and pre-processing the source schedule and the target schedule includes eliminating predetermined schedules or invalid schedules.

In some embodiments, determining validity of migration of jobs may include identifying correct predecessors for each job based on whether a specific predecessor job is listed as a successor in any other job's definition.

In some embodiments, determining validity of migration of jobs between the source schedule and the target schedule may include using a first set of rules for schedules for the one or more distributed systems and a second set of rules for schedules for the one or more mainframe systems.

In some embodiments, either (i) the source scheduler generates schedules that have job names with at least a predetermined number of characters and the target scheduler generates schedules that uses application identifiers having a predetermined size, or (ii) the target scheduler generates schedules that have job names with at least a predetermined number of characters and the source scheduler generates schedules that uses application identifiers having a predetermined size.

In some embodiments, determining validity of migration of jobs may include in accordance with a determination that the source schedule and the target schedule corresponds to the one or more distributed systems, using a distributed system schedule validation pattern. In some embodiments, determining validity of migration of jobs may include in accordance with a determination that the source schedule and the target schedule corresponds to the one or more mainframe systems, using a mainframe system schedule validation pattern.

In some embodiments, determining validity of migration of jobs may include identifying one or more mismatches between the source schedule and the target schedule using one or more pattern matching techniques.

In some embodiments, determining validity of migration of jobs may include identifying one or more source schedule matching parameters and one or more target schedule matching parameters. In some embodiments, determining validity of migration of jobs may include identifying matching schedules from the one or more source schedule matching parameters and the one or more target schedule matching parameters. In some embodiments, determining validity of migration of jobs may include identifying non-matching schedules from the one or more source schedule matching parameters and the one or more target schedule matching parameters. In some embodiments, determining validity of migration of jobs may include identifying non-matching schedules in the one or more source schedule matching parameters from the one or more target schedule matching parameters. In some embodiments, determining validity of migration of jobs may include identifying non-matching schedules in the one or more target schedule matching parameters from the one or more source schedule matching parameters.

In some embodiments, determining validity of migration of jobs may include extracting a first list of predecessors for the source schedule and a second list of predecessors for the target schedule, and comparing the first list and the second list to generate a comparison report.

In some embodiments, the method may further include generating a report based on predecessor jobs of the source schedule and/or the target schedule with broken linkages.

In some embodiments, the method may further include providing an interface to query job names to retrieve schedule details for the source schedule and the target schedule, and/or in response to receiving a job name, returning schedule details for the source schedule or the target schedule corresponding to the job name.

In some embodiments, a computer system has one or more processors, memory, and a display. The one or more programs include instructions for performing any of the methods described herein.

In some embodiments, a non-transitory computer readable storage medium stores one or more programs configured for execution by a computer system having one or more processors, memory, and a display. The one or more programs include instructions for performing any of the methods described herein.

### BRIEF DESCRIPTION OF THE DRAWINGS

FIG. 1 is a schematic diagram of an example system for validating and/or merging schedules for mainframe systems and/or distributed systems, according to some embodiments;

FIG. 2 shows a flow chart of an example process for validation and/or merging schedules for distributed systems and/or mainframe systems, according to some embodiments;

FIG. 3A shows an example list for a list of jobs, according to some embodiments;

FIG. 3B shows an example source schedule for a mainframe system, according to some embodiments;

FIG. 3C shows an example target schedule for a mainframe system or a distributed system, according to some embodiment;

FIGS. 4A and 4B show an example of schedule preprocessing, according to some embodiments;

FIGS. 5A-5D show example validation reports, according to some embodiments;

FIGS. 6A and 6B show example validation reports, according to some embodiments;

FIG. 6C shows an example processing of invalid schedules, according to some embodiments;

FIGS. 7A and 7B show example graph plots for jobs migrated successfully over a period of time, according to some embodiments; and

FIG. 8 shows a flowchart of an example method for migrating and/or validating schedules for mainframe systems and/or distributed systems, according to some embodiments.

### DETAILED DESCRIPTION OF THE PREFERRED EMBODIMENTS

The following descriptions of embodiments of the invention are exemplary, rather than limiting, and many variations and modifications are within the scope and spirit of the invention. Although numerous specific details are set forth in order to provide a thorough understanding of the present invention, it will be apparent to one of ordinary skill in the art, that embodiments of the invention may be practiced without these specific details. In other instances, well-known features have not been described in detail in order to avoid unnecessarily obscuring the present invention.

One or more embodiments of the invention are directed to an improved method and system for migrating and/or validating schedules for distributed systems and/or mainframe systems. Some embodiments verify that job linkages between different schedulers are accurately configured with proper predecessor and successor relationships. Some embodiments facilitate efficient verification of migrated schedules by providing a schedule validator for application owners. Some embodiments determine whether a specific predecessor job is listed as a successor in any other job's definition. Some embodiments use multiple validation iterations rather than text parsing, which can be error-prone in identifying predecessors of a job.

Some embodiments facilitate migration and/or validation for mainframe and distributed systems. The pre-requisites for these systems may be different. For example, for distributed systems, some schedulers may use a job name with a predetermined number of characters (e.g., more than 55 characters), while other schedulers may use an application identifier (e.g., an 8-byte application identifier). Some embodiments compare source and target schedules having different formats. Some embodiments validate all jobs scheduled by a scheduler to identify discrepancies. Some embodiments identify broken linkages on converted (or migrated) schedules. Some embodiments use knowledge of job linkages defined in different schedulers. In some embodiments, a platform features a user-friendly interface that enables end-users to provide necessary inputs to identify differences at the job level, minimizing the need for validation intervention. Some embodiments allow users to provide highly refined job dependencies, improving accuracy and efficiency in validation and migration.

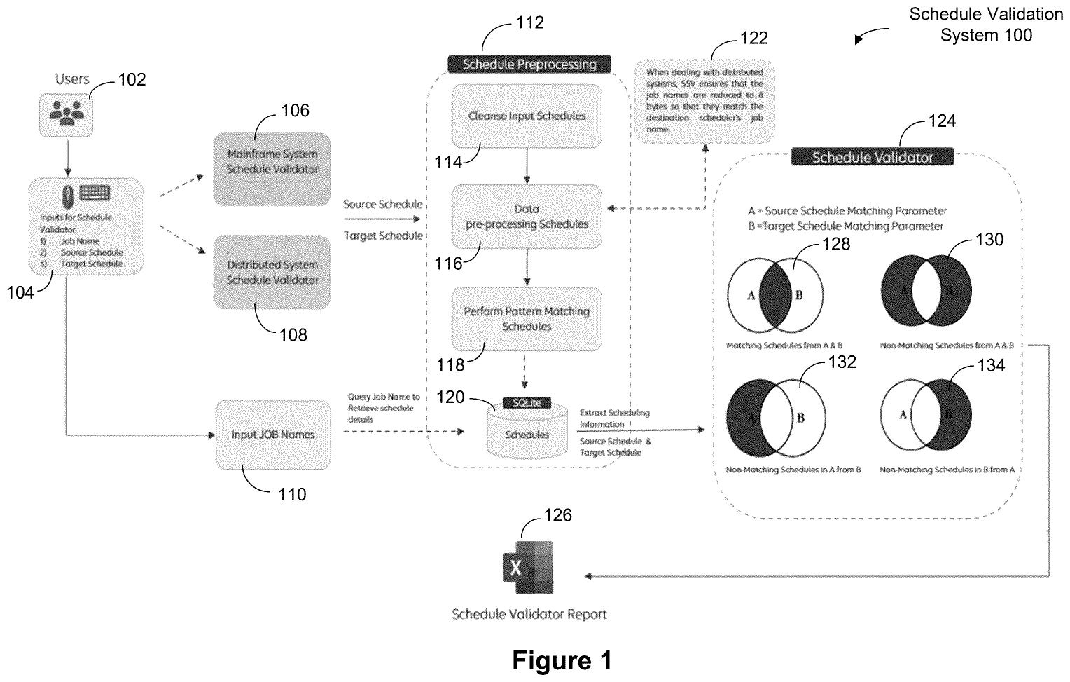

FIG. 1 is a schematic diagram of an example system 100 for validating and/or merging schedules for mainframe systems and/or distributed systems, according to some embodiments. The diagram shows various components that may be implemented in a single cycle of a continuous improvement process for validating and/or migrating schedules. Users 102 may input one or more inputs 104 for schedule validation. In some embodiments, the users 102 may be interfaces to schedulers that may produce schedules for distributed systems and/or mainframe systems. The users 102 may be automatic systems that interface and/or obtain the required user input. The users 102 may control the schedulers to correct incorrect or invalid schedules. A job list may be input and may contain a comprehensive list of jobs for which a user expects a comparison report between different schedulers (e.g., CTM and ESP scheduler software). The job list may be in the form of a spreadsheet or have a tabular format. A source schedule definition may be input that may contain a job definition report for a source scheduler for a specific region or system; the source schedule definition may be provided as text file. This file may serve as a reference for obtaining the predecessor and successor for a given job. A target scheduling definition may be input. This definition may contain the job definition report for a target scheduler for a specific region/system. The definition may be provided as another text file. This file may serve as a reference for obtaining the predecessor and successor for a given job. A validator process may be performed against given input files. The validation may be performed concurrently on different input files. The validation may be performed while the schedules are queued or used by different systems and/or while executing batch jobs on different or same systems.

A mainframe schedule validator 106 and/or a distributed system validator 108 may be provided. The schedule validators may have different requirements, capabilities and/or output, as described below. After obtaining the source schedule (e.g., a schedule generated by a current system or scheduler) and the target schedule (e.g., a schedule generated by a target system or scheduler where the scheduling is migrated to), the schedulers perform schedule preprocessing (112). The preprocessing may include cleansing (114) of input schedules, data pre-processing (116) of the schedules, performing pattern matching (118) on the schedules, and generating (120) schedules (e.g., using SQLite). The data pre-processing may include formatting source and/or target dump files (e.g., files in XML format) to prepare files for merging and/or validation. For each job, the system may extract a list of predecessors for both source and target schedulers. Some embodiments reconcile differences in formats (e.g., CTM jobs use more than 55 bytes and ESP jobs use 8 bytes) by converting jobs to their corresponding job names and/or by performing a matching process.

For illustration, for cleansing/pre-processing that may require normalization across systems, suppose the migration is from CTM to ESP scheduler for both mainframe and distributed systems. In the case of mainframe systems, a source (e.g., CTM) schedule may include job names that are 8 bytes each, a target (e.g., ESP) schedule may include job names that are 8 bytes each. In the case of distributed systems, however, a source (e.g., CTM) schedule may include job names that are between 8 and 55 bytes each, and a target (e.g., ESP) schedule may include job names that are 8 bytes each. Since the source and target are not in same format, the target (ESP) schedule may be converted from the 55 byte job names to 8 byte job names to normalize the job names across the schedulers.

A schedule validator 124 may use scheduling information extracted from the schedules 120 to compare predecessor lists and/or generate a comparison report 126. The schedule validator 124 may compare source schedule matching parameter and target schedule matching parameter, to generate matching schedules 128 from the source schedule and the target schedule, non-matching schedules 130 from the source schedule and the target schedule, non-matching schedules 132 in the source schedule from the target schedule, and/or non-matching schedules 134 in the target schedule from the source schedule. Matching Parameters may include source predecessors (e.g., CTM predecessors), target predecessors (e.g., ESP predecessors), and/or job start times and end times for source and target. Comparison parameters may include CTM predecessors versus ESP predecessors, CTM job start time, end time versus ESP job start time, end time, and so on. Resulting set may include predecessor or time matching between the schedulers. For example, this may include predecessor time for CTM mismatch (e.g., available in CTM but absent in ESP), predecessor time for ESP Mismatch (e.g., available in ESP but absent in CTM).

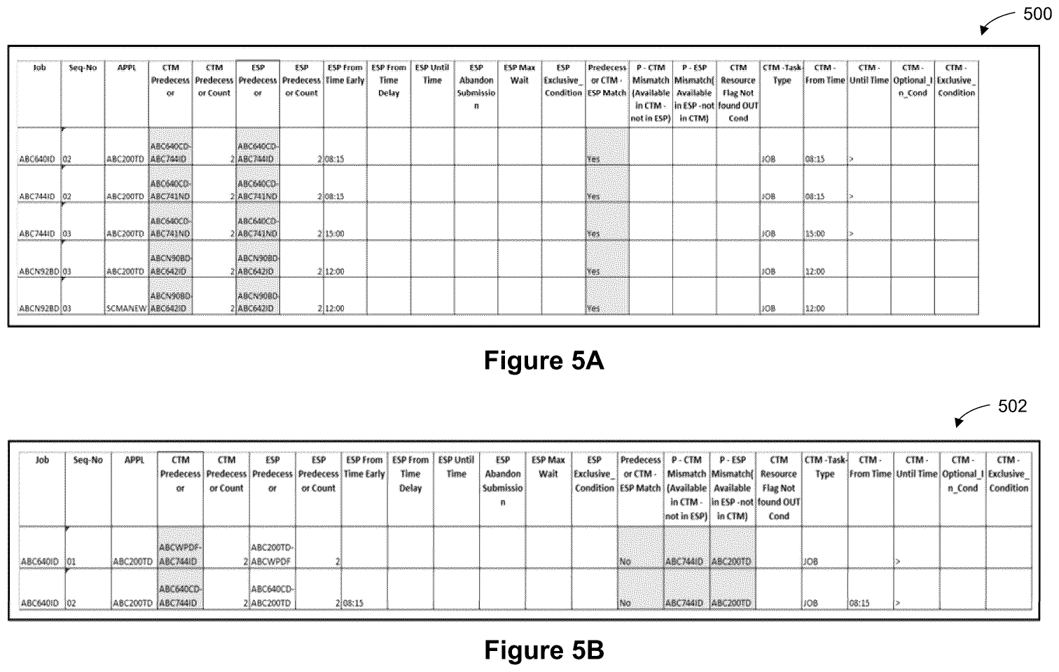

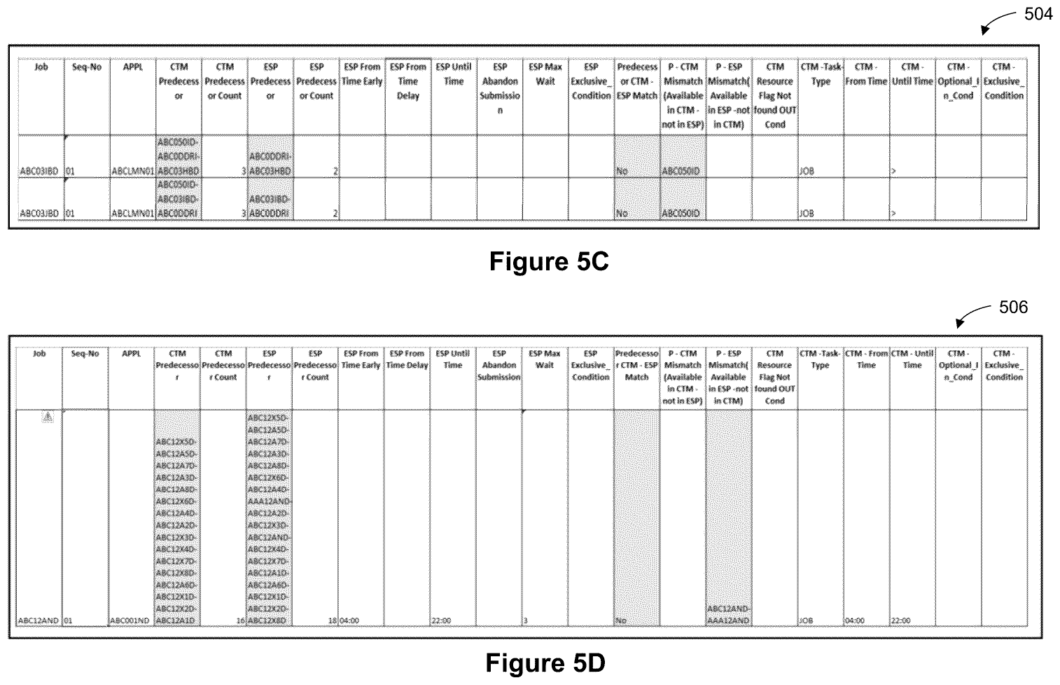

Some embodiments generate comparison reports for schedule validation and/or migration, as described below in reference to FIGS. 5A-5D. Any type of report and/or format that may be processed by automatic schedule correction modules may be used for the comparison report.

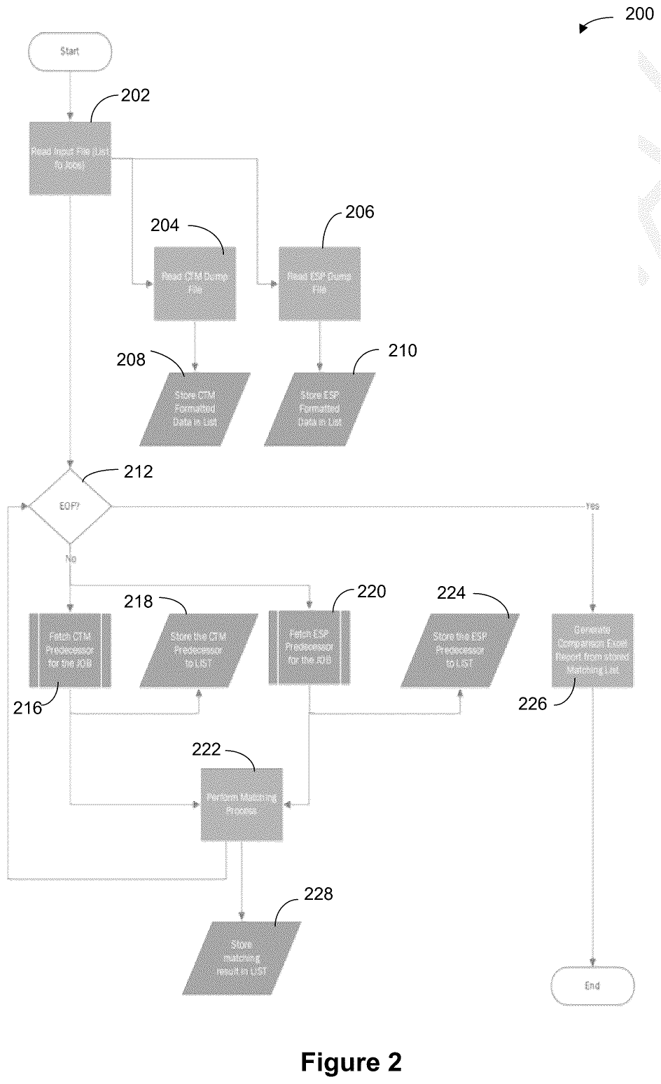

FIG. 2 shows a flow chart of an example process 200 for validation and/or merging schedules for distributed systems and/or mainframe systems, according to some embodiments. A user may provide one or more input files. The process may read (202) the input files (e.g., a job list). The process may read (204 and 206, for the different schedulers) dump files (e.g., CTM dump files, ESP dump files). The process may preprocess and/or format (steps 208 and 210 for the source scheduler and the target scheduler, respectively) the dump files and/or store same into one or more lists. The process may iterate (212) as long as the input file (e.g., job lists) is not end of file. The process may fetch (216) a predecessor from the stored formatted list and determine whether the job has a predecessor or not. Then the process may store (218) the job in a final predecessors list. The process may also fetch (220) a predecessor from the stored formatted list for a target scheduler and determine whether the job has a valid predecessor. Then the process may store (224) the predecessor to a target predecessor list. After the predecessors are identified, the process may perform (222) a matching process by comparing the source predecessor and the target predecessor for a given job to identify any broken linkages. The process may then store (228) the results in a matching container. Some embodiments may perform (212) one or more of the preceding steps until the end of file is reached for one or more input files. Subsequently, the process may generate (226) a report using information parsed from the input files. In this way, the process makes validation and/or merging more efficient than manual process. Average processing time for analyzing each job can be improved. Some embodiments provide job information for specific jobs from schedulers, facilitating analysis for application teams and/or automatic schedule correction modules.

Some embodiments generate the comparison report between the different schedules (e.g., CTM and ESP) and/or reports for predecessor jobs with broken linkages from ESP after conversion. Some embodiments may identify mismatches between the schedulers. Some embodiments reduce the risk of scheduling inconsistencies across systems, mitigates the adverse effects on downstream processes. Each schedule validation may take several seconds (e.g., 40 seconds). Multiple executions of the schedule validator may improve accuracy. For example, the validation may be performed in stages, whereby a first stage provides an initial and/or quick validation of the schedules, followed by subsequent stages where the validation is performed more exhaustively. In some situations, an exhaustive validation process may be necessary so a complete migration may be performed. The validation may be performed in stages as applied to different portions of a schedule and/or different portions of different schedules. Some embodiments facilitate the retrieval of job schedule dependencies, allowing application owners and/or automatic schedule correction to validate and/or migrate job execution.

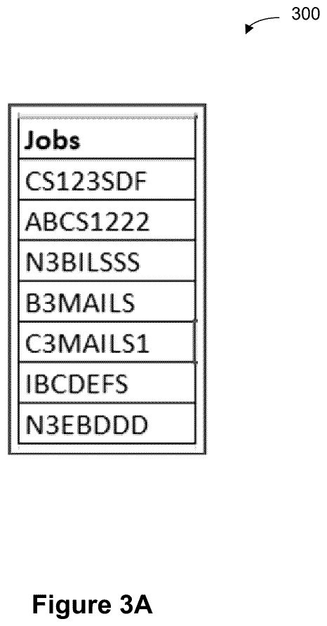

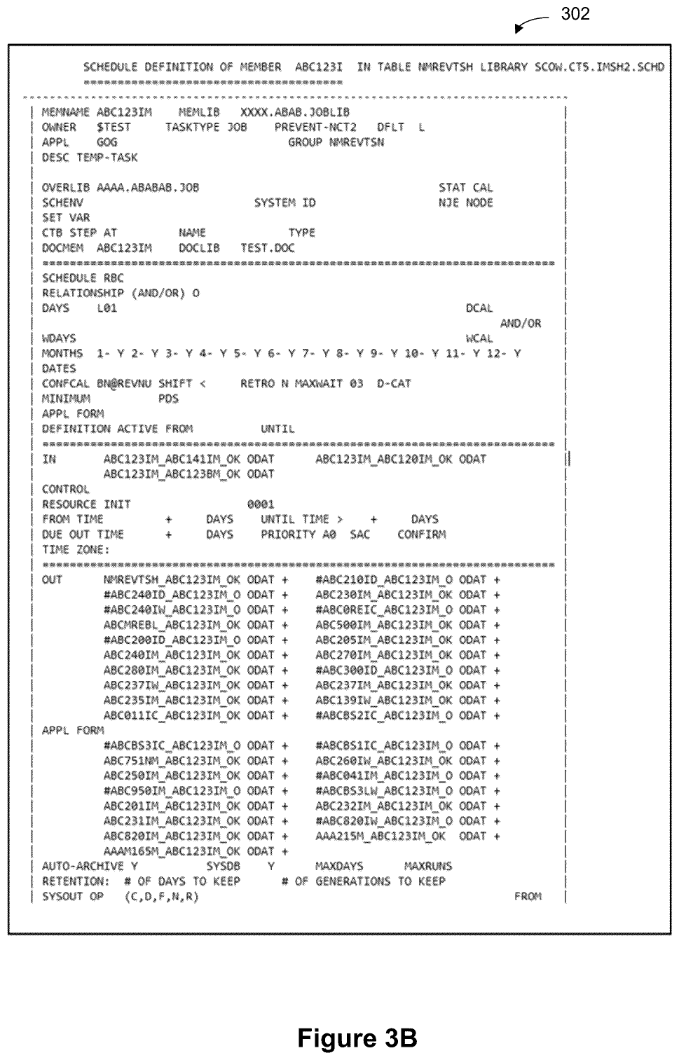

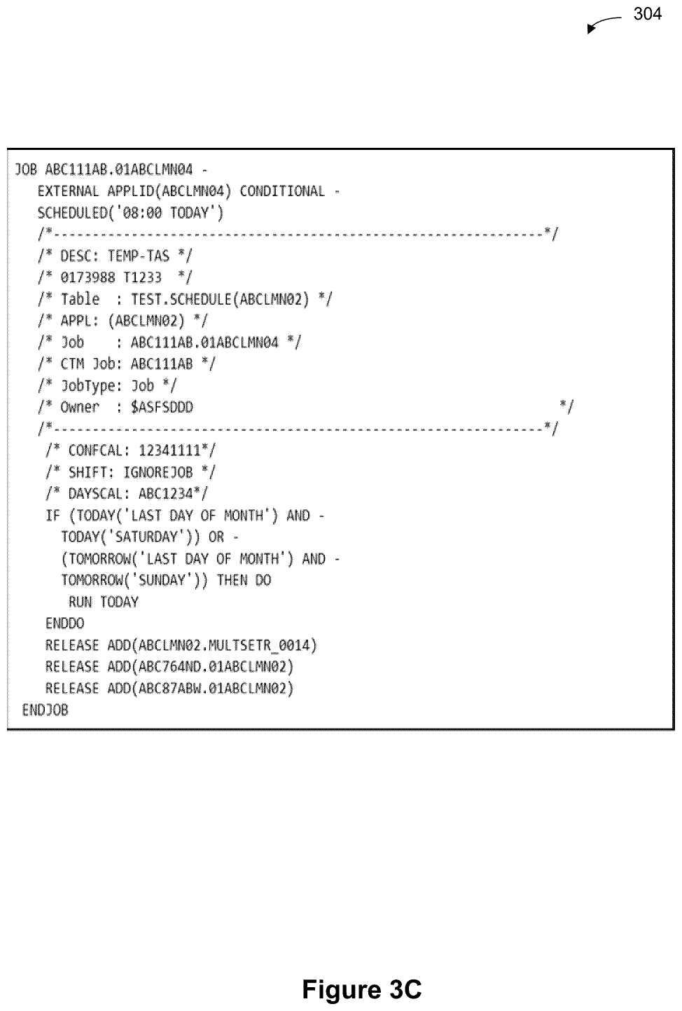

FIG. 3A shows an example list 300 for a list of jobs, according to some embodiments. A user (or an automatic retrieval module may interface with schedulers) to obtain the list of job names (e.g., a spreadsheet having an appropriate header).

FIG. 3B shows an example source schedule 302 for a mainframe system, according to some embodiments. The source schedule may be provided in a text format, or any format suitable for automatic and/or concurrent processing.

FIG. 3C shows an example target schedule 304 for a mainframe system or a distributed system, according to some embodiments. The target schedule may be provided in a text format, or any format suitable for automatic and/or concurrent processing.

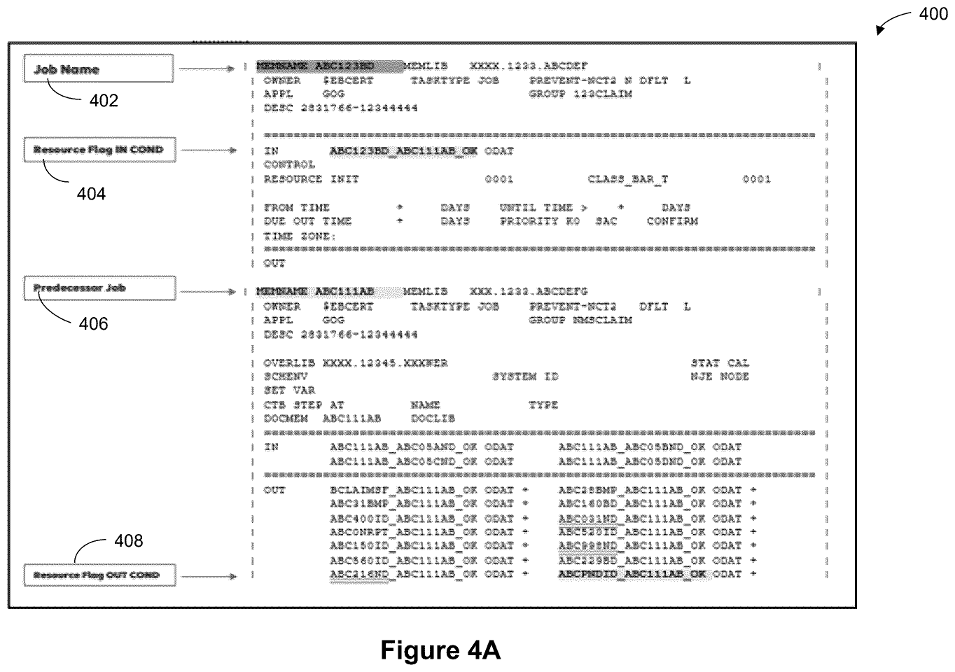

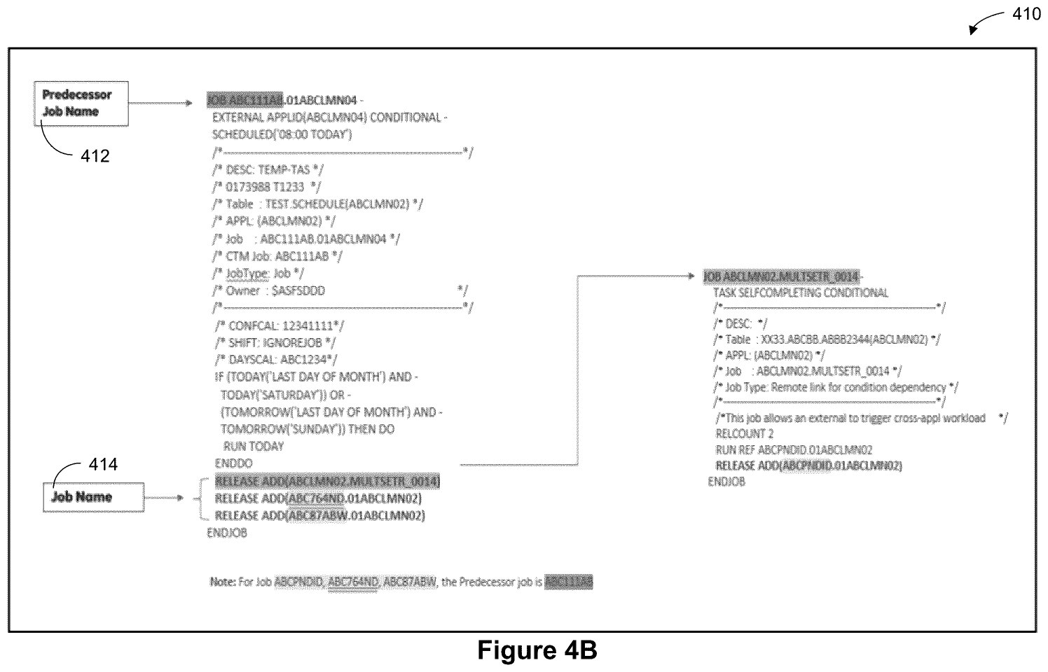

FIGS. 4A and 4B show an example of schedule preprocessing, according to some embodiments. FIG. 4A shows an example source schedule 400 for a scheduler, such as CTM. Job name 402, resource flag in condition 404, predecessor job 406, and resource flag out condition 408 are shown. FIG. 4B shows an example target schedule 410 for a scheduler, such as ESP. Predecessor job name 412 and job name 414 are shown.

FIGS. 5A-5D show example validation reports, according to some embodiments. FIG. 5A shows an example validation report 500 for matching schedules from a source scheduler and a target scheduler. FIG. 5B shows an example validation report 502 for non-matching Schedules from a source scheduler and a target scheduler. For example, schedules from a CTM predecessor may not match with schedules from an ESP predecessor. FIG. 5C shows an example validation report 504 for non-matching schedules in a source schedule from a target schedule. For example, this may include instances that are present in a CTM schedule but absent in an ESP Schedule. FIG. 5D shows an example validation report 506 for non-matching Schedules in a target schedule from a source schedule. For example, this may include schedules or jobs available in an ESP schedule but absent in a CTM Schedule. Application owners and/or automatic schedule correction modules may review the mismatch and/or report to a target scheduler to fix the schedule.

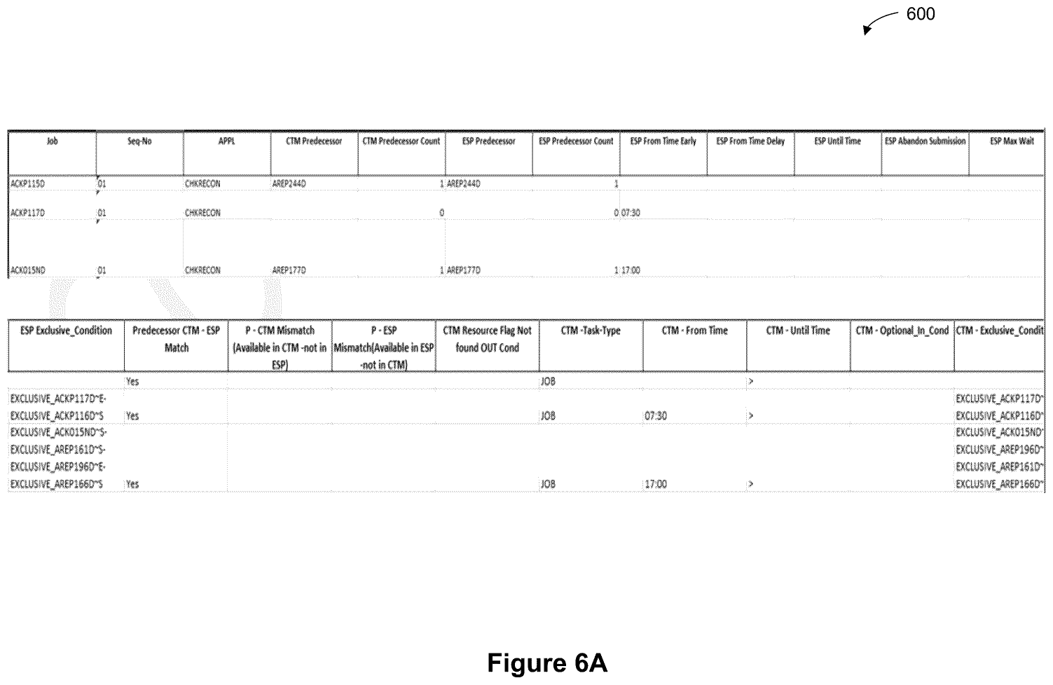

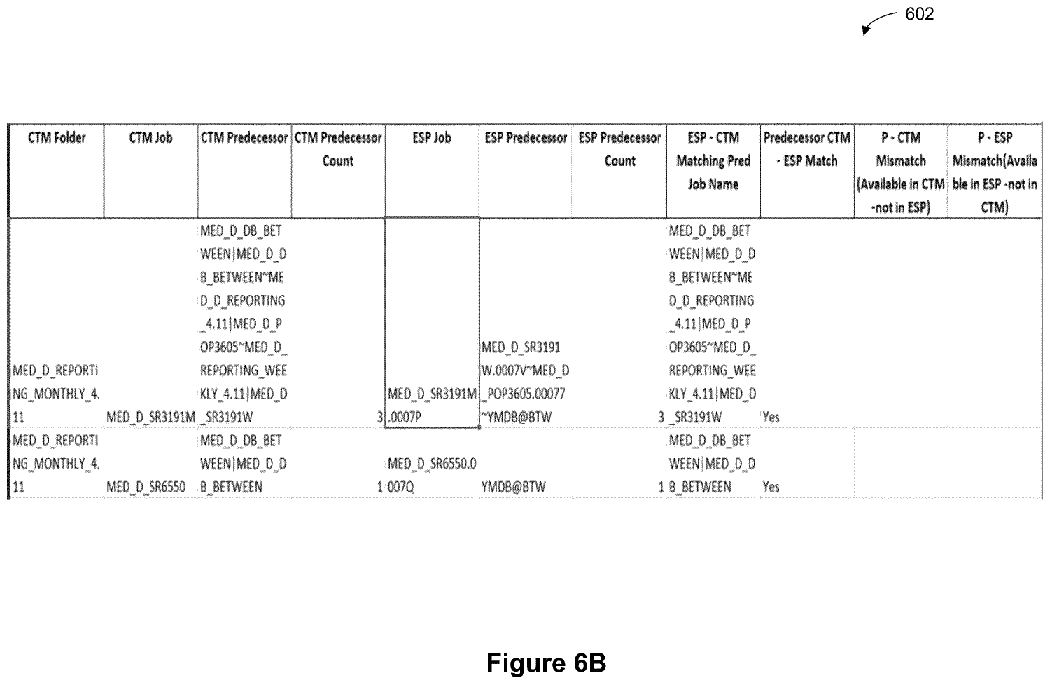

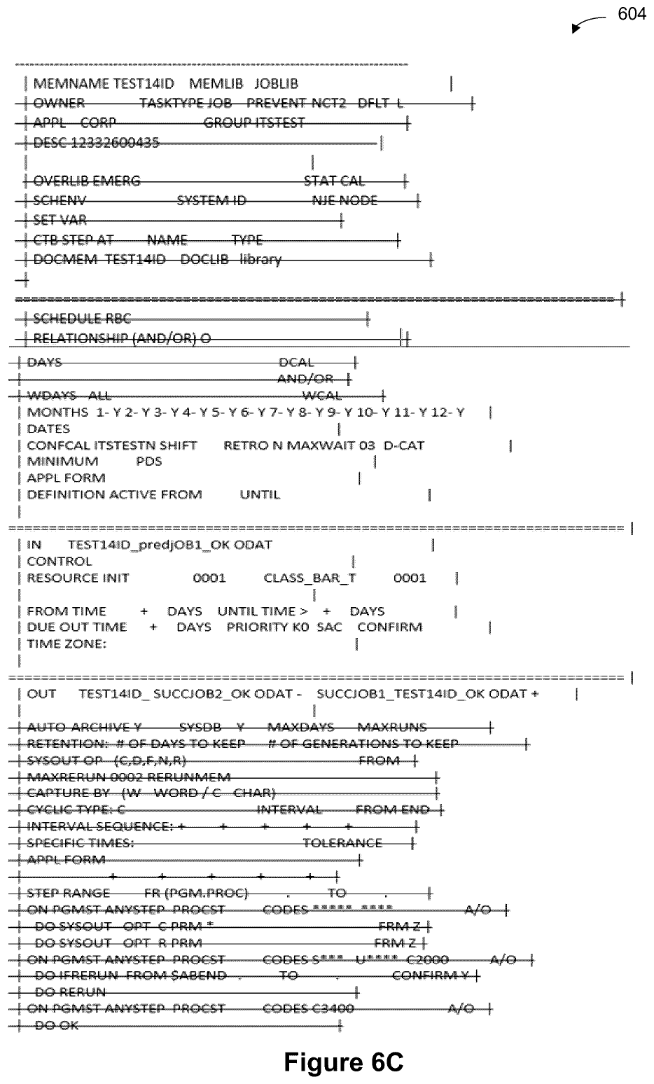

FIGS. 6A and 6B show example validation reports, according to some embodiments. FIG. 6A shows an example mainframe schedule validator sample report 600, according to some embodiments. Based on input, the techniques described herein may be used to preprocess and format both the CTM dump and ESP dump files to prepare them for the comparison process. For each job, some embodiments may extract the list of predecessors for both CTM and ESP. The validator may then compare the two predecessor lists and generate a comparison report, an example format of which is shown in FIG. 6A. FIG. 6B shows an example distributed systems schedule validator sample report 602, according to some embodiments. Based on input, the techniques described herein may be used to preprocess and format both CTM dump (e.g., a dump file in XML format) and ESP dump file to prepare them for the comparison process. For each job, some embodiments may retrieve the list of predecessors for both CTM and ESP. Some embodiments generate a comparison report, an example of which is shown in FIG. 6B.

FIG. 6C shows an example processing 604 of invalid schedules, according to some embodiments. Invalid schedules may be filtered or removed (e.g., struck information in the example) during the validation process; such information may not be required for the validation process. A job schedule definition may include IN conditions and OUT conditions. A schedule may be valid only if its IN conditions flag (e.g., TEST14ID_predjOB1_OK) is found in the OUT conditions (e.g., TEST14ID_predjOB1_OK) of any of its job definitions. Otherwise, the schedule may be invalid. By using this logic, some embodiments may filter out the invalid schedules and only consider the valid ones. During an initial analysis, the application team or the system 100 may identify a list of jobs that are no longer used or decommissioned. These jobs may be part of the invalid schedules that will be excluded from the validation process.

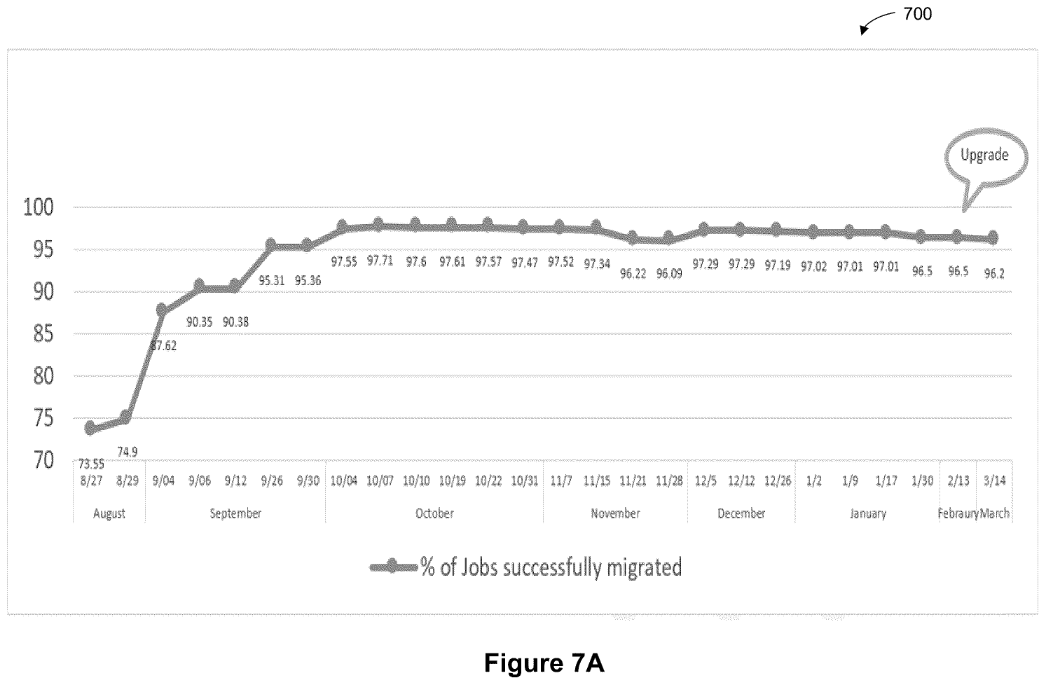

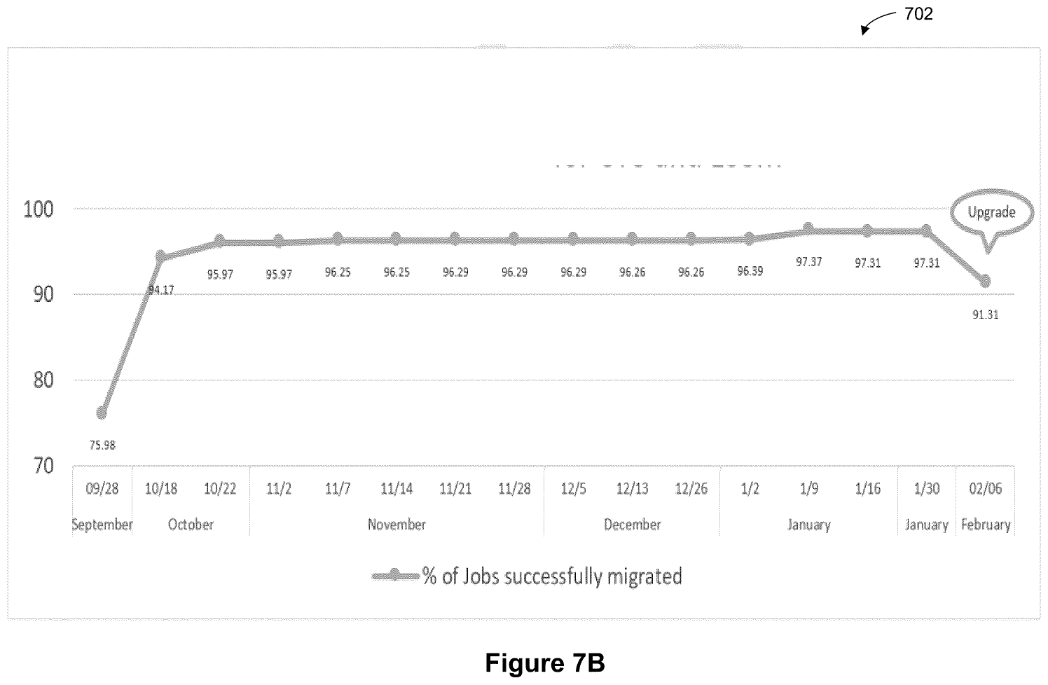

FIGS. 7A and 7B show example graph plots 700 and 702, for jobs migrated successfully over a period of time, according to some embodiments. FIG. 7A is a trend chart for successful migration of jobs from CT5 (a source scheduler) to ES5M (a target scheduler). FIG. 7B is a trend chart for successful migration of jobs from CT8 (a source scheduler) to ES8M (a target scheduler). As the plots indicate, the successful migration percentage may initially increase, stabilize, and subsequently drop over a period of time, in which case the schedule validators may be updated (e.g., with new rules, patterns).

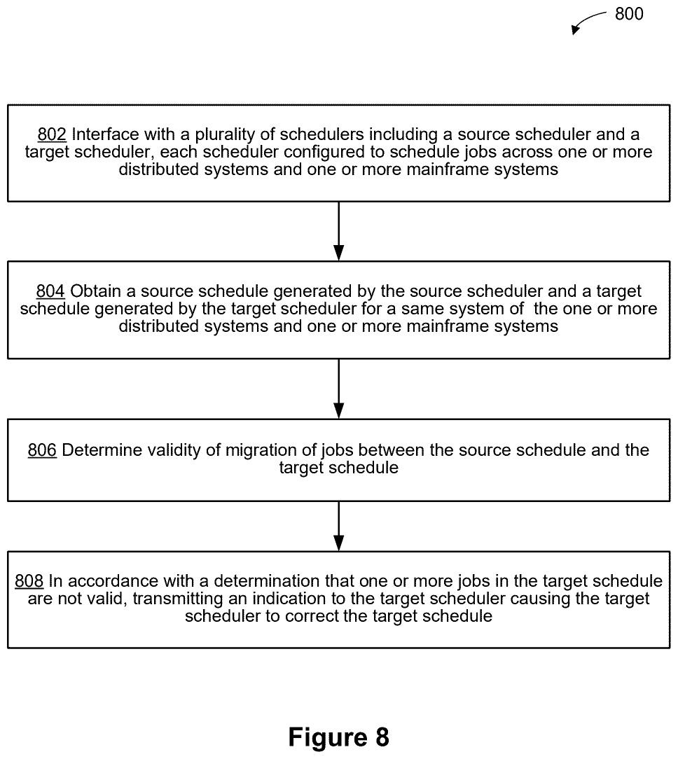

FIG. 8 shows a flowchart of an example method 800 for migrating and/or validating schedules for mainframe systems and/or distributed systems, according to some embodiments. The method may be performed by the system 100, and/or at a server having one or more processors, memory, one or more displays, and one or more programs stored in the memory and configured for execution by the one or more processors, the one or more programs including instructions for performing the steps described herein.

The method may include interfacing (802) with a plurality of schedulers including a source scheduler and a target scheduler (e.g., via the users 102). Each scheduler may be configured to schedule jobs across one or more distributed systems and one or more mainframe systems.

The method may include obtaining (804) a source schedule generated by the source scheduler and a target schedule generated by the target scheduler for a same system of the one or more distributed systems and one or more mainframe systems. For example, in FIG. 1, users 102 (or any automatic interface to schedulers) may obtain the inputs 104, examples of which are described above in reference to FIGS. 3A-3C, according to some embodiments. In some embodiments, either (i) the source scheduler generates schedules that have job names with at least a predetermined number of characters and the target scheduler generates schedules that uses application identifiers having a predetermined size, or (ii) the target scheduler generates schedules that have job names with at least a predetermined number of characters and the source scheduler generates schedules that uses application identifiers having a predetermined size.

The method may include determining (806) validity of migration of jobs between the source schedule and the target schedule. In some embodiments, the method may further include, prior to determining validity of migration of jobs, cleansing and pre-processing the source schedule and the target schedule. In some embodiments, cleansing and pre-processing the source schedule and the target schedule includes eliminating predetermined schedules or invalid schedules. In some embodiments, determining validity of migration of jobs may include identifying correct predecessors for each job based on whether a specific predecessor job is listed as a successor in any other job's definition. In some embodiments, determining validity of migration of jobs between the source schedule and the target schedule may include using a first set of rules for schedules for the one or more distributed systems and a second set of rules for schedules for the one or more mainframe systems.

In some embodiments, determining validity of migration of jobs may include in accordance with a determination that the source schedule and the target schedule corresponds to the one or more distributed systems, using a distributed system schedule validation pattern. In some embodiments, determining validity of migration of jobs may include in accordance with a determination that the source schedule and the target schedule corresponds to the one or more mainframe systems, using a mainframe system schedule validation pattern.

In some embodiments, determining validity of migration of jobs may include identifying one or more mismatches between the source schedule and the target schedule using one or more pattern matching techniques. The pattern matching may include regular expression.

In some embodiments, determining validity of migration of jobs may include identifying one or more source schedule matching parameters and one or more target schedule matching parameters. In some embodiments, determining validity of migration of jobs may include identifying matching schedules from the one or more source schedule matching parameters and the one or more target schedule matching parameters. In some embodiments, determining validity of migration of jobs may include identifying non-matching schedules from the one or more source schedule matching parameters and the one or more target schedule matching parameters. In some embodiments, determining validity of migration of jobs may include identifying non-matching schedules in the one or more source schedule matching parameters from the one or more target schedule matching parameters. In some embodiments, determining validity of migration of jobs may include identifying non-matching schedules in the one or more target schedule matching parameters from the one or more source schedule matching parameters.

In some embodiments, determining validity of migration of jobs may include extracting a first list of predecessors for the source schedule and a second list of predecessors for the target schedule, and comparing the first list and the second list to generate a comparison report.

Some embodiments compare and/or validate dataset triggers between the source schedule and the target schedule. For example, validation may be performed on execution of the application job which runs when the file is created/received from different systems/sources. Some embodiments compare and/or validate cyclic Jobs between the source schedule and the target schedule. For example, validation may be performed on execution of the application job which runs multiple times in a day (e.g., every 15 or 30 min depending on the definitions).

To validate accuracy, in some embodiments, the source scheduler and the target scheduler may be executed in parallel in separate test environments. Job logs from each of these environments may be captured and compared to identify discrepancy between pre- and post-migration processing. After the comparison results are consistently successful, target scheduler may be installed in the production environment. The source scheduler may be decommissioned post install.

The method may include, in accordance with a determination that one or more jobs in the target schedule are not valid, transmitting (808) an indication to the target scheduler causing the target scheduler to correct the target schedule. In some embodiments, the comparison reports described earlier may be used by a target scheduling team to fix broken linkages to align with a source schedule definition. For example, suppose there are 10 broken linkages issues between CTM (source) and ESP (target). A comparison report may be shared with the ESP to fix the issues in ESP to align the schedule with the CTM schedule.

In some embodiments, the method may further include generating a report based on predecessor jobs of the source schedule and/or the target schedule with broken linkages. In some embodiments, the method may further include generating a report identifying mismatches between the source schedule and the target schedule.

In some embodiments, the method may further include providing an interface to query job names to retrieve schedule details for the source schedule and/or the target schedule, and/or in response to receiving a job name, returning schedule details for the source schedule or the target schedule corresponding to the job name. The query interface may allow developers to directly access the scheduling definition without accessing mainframe systems. The developers may view a defined set of IN conditions and OUT conditions for end-to-end application analysis purposes.

Some embodiments handle different application groups in multiple servers. Applications may be hosted on different servers that may add an additional layer of complexity. Dependencies and configuration of each application group may need to be preserved and required to be compatible with the target environment. The performance and functionality of each application group may require focused validation to prevent any impact.

In some embodiments, job status information may be used to monitor the progress and outcome of the migration. This information may be used to troubleshoot any run-time issues that may arise. Job status information may also be used to validate that the migrated jobs are running as expected and producing the desired results.

Some embodiments ensure that events that trigger the jobs (for event-based workloads) are consistent and reliable across different environments.

Some embodiments perform validation across enterprise applications, across different operating systems, and/or hybrid and/or multi-cloud environments. The techniques described herein are flexible and may be applied across different environments, and may be applied simultaneously across such platforms or systems. For mainframe systems, the schedulers (e.g., CTM, ESP) may operate within the mainframe systems, whereas for distributed systems, schedulers (e.g., CTM) may operate outside the mainframe and the schedulers (e.g., ESP) may operate within the mainframe systems.

While embodiments and alternatives have been disclosed and discussed, the invention herein is not limited to the particular disclosed embodiments or alternatives but encompasses the full breadth and scope of the invention including equivalents, and the invention is not limited except as set forth in and encompassed by the full breadth and scope of the claims herein.

What is claimed is:

1. A method for migrating and validating schedules, the method comprising:
interfacing with a plurality of schedulers including a source scheduler and a target scheduler, each scheduler configured to schedule jobs across one or more distributed systems and one or more mainframe systems;
obtaining a source schedule generated by the source scheduler and a target schedule generated by the target scheduler for a same system of the one or more distributed systems and one or more mainframe systems; and
determining validity of migration of jobs between the source schedule and the target schedule; and
in accordance with a determination that one or more jobs in the target schedule are not valid, transmitting an indication to the target scheduler causing the target scheduler to correct the target schedule.

2. The method of claim 1, further comprising:
prior to determining validity of migration of jobs:
cleansing and pre-processing the source schedule and the target schedule.

3. The method of claim 2, wherein cleansing and pre-processing the source schedule and the target schedule comprises eliminating predetermined schedules or invalid schedules.

4. The method of claim 1, wherein determining validity of migration of jobs comprises:
identifying correct predecessors for each job based on whether a specific predecessor job is listed as a successor in any other job's definition.

5. The method of claim 1, wherein determining validity of migration of jobs between the source schedule and the target schedule comprises using a first set of rules for schedules for the one or more distributed systems and a second set of rules for schedules for the one or more mainframe systems.

6. The method of claim 1, wherein either (i) the source scheduler generates schedules that have job names with at least a predetermined number of characters and the target scheduler generates schedules that uses application identifiers having a predetermined size, or (ii) the target scheduler generates schedules that have job names with at least a predetermined number of characters and the source scheduler generates schedules that uses application identifiers having a predetermined size.

7. The method of claim 1, wherein determining validity of migration of jobs comprises:
in accordance with a determination that the source schedule and the target schedule corresponds to the one or more distributed systems, using a distributed system schedule validation pattern; and
in accordance with a determination that the source schedule and the target schedule corresponds to the one or more mainframe systems, using a mainframe system schedule validation pattern.

8. The method of claim 1, wherein determining validity of migration of jobs comprises identifying one or more mismatches between the source schedule and the target schedule using one or more pattern matching techniques.

9. The method of claim 1, wherein determining validity of migration of jobs comprises:
identifying one or more source schedule matching parameters and one or more target schedule matching parameters;
identifying matching schedules from the one or more source schedule matching parameters and the one or more target schedule matching parameters;
identifying non-matching schedules from the one or more source schedule matching parameters and the one or more target schedule matching parameters;
identifying non-matching schedules in the one or more source schedule matching parameters from the one or more target schedule matching parameters; and
identifying non-matching schedules in the one or more target schedule matching parameters from the one or more source schedule matching parameters.

10. The method of claim 1, wherein determining validity of migration of jobs comprises:
extracting a first list of predecessors for the source schedule and a second list of predecessors for the target schedule; and
comparing the first list and the second list to generate a comparison report.

11. The method of claim 1, further comprising:
generating a report based on predecessor jobs of the source schedule and/or the target schedule with broken linkages.

12. The method of claim 1, further comprising:
providing an interface to query job names to retrieve schedule details for the source schedule and the target schedule; and
in response to receiving a job name, returning schedule details for the source schedule or the target schedule corresponding to the job name.

13. A system for migrating and validating schedules, the system comprising:
a display;
one or more processors; and
memory storing one or more programs comprising instructions for:
interfacing with a plurality of schedulers including a source scheduler and a target scheduler, each scheduler configured to schedule jobs across one or more distributed systems and one or more mainframe systems;
obtaining a source schedule generated by the source scheduler and a target schedule generated by the target scheduler for a same system of the one or more distributed systems and one or more mainframe systems;
determining validity of migration of jobs between the source schedule and the target schedule; and
in accordance with a determination that one or more jobs in the target schedule are not valid, transmitting an indication to the target scheduler causing the target scheduler to correct the target schedule.

14. The system of claim 13, wherein the one or more programs further comprise instructions for:
prior to determining validity of migration of jobs:
cleansing and pre-processing the source schedule and the target schedule.

15. The system of claim 14, wherein cleansing and pre-processing the source schedule and the target schedule comprises eliminating predetermined schedules or invalid schedules.

16. The system of claim 13, wherein determining validity of migration of jobs comprises:
identifying correct predecessors for each job based on whether a specific predecessor job is listed as a successor in any other job's definition.

17. The system of claim 13, wherein determining validity of migration of jobs between the source schedule and the target schedule comprises using a first set of rules for schedules for the one or more distributed systems and a second set of rules for schedules for the one or more mainframe systems.

18. The system of claim 13, wherein either (i) the source scheduler generates schedules that have job names with at least a predetermined number of characters and the target scheduler generates schedules that uses application identifiers having a predetermined size, or (ii) the target scheduler generates schedules that have job names with at least a predetermined number of characters and the source scheduler generates schedules that uses application identifiers having a predetermined size.

19. The system of claim 13, wherein determining validity of migration of jobs comprises:
in accordance with a determination that the source schedule and the target schedule corresponds to the one or more distributed systems, using a distributed system schedule validation pattern; and
in accordance with a determination that the source schedule and the target schedule corresponds to the one or more mainframe systems, using a mainframe system schedule validation pattern.

20. A non-transitory computer readable storage medium storing one or more programs configured for execution by a computer system having a display, memory and one or more processors, the one or more programs comprising instructions for:
interfacing with a plurality of schedulers including a source scheduler and a target scheduler, each scheduler configured to schedule jobs across one or more distributed systems and one or more mainframe systems;
obtaining a source schedule generated by the source scheduler and a target schedule generated by the target scheduler for a same system of the one or more distributed systems and one or more mainframe systems;
determining validity of migration of jobs between the source schedule and the target schedule; and
in accordance with a determination that one or more jobs in the target schedule are not valid, transmitting an indication to the target scheduler causing the target scheduler to correct the target schedule.
